(19) United States
(12) Patent Application Publication
(10) Pub. No.: US 2008/0299255 A1
(43) Pub. Date: Dec. 4, 2008

(54) JUICE BEVERAGES WITH PROBIOTIC BACTERIA

(75) Inventors: Sallie Kim, Newtown, PA (US); Lorenzo C. Nicastro, Newtown, PA (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Naked Juice Co. of Glendora, Inc., Azusa, CA (US)

(21) Appl. No.: 12/110,746

(22) Filed: Apr. 28, 2008

Related U.S. Application Data
(60) Provisional application No. 60/914,476, filed on Apr. 27, 2007.

(51) Int. Cl. A23L 2/52; A23L 2/02

(52) U.S. Cl. 426/51; 426/61

(57) ABSTRACT

Fruit juice beverages comprising probiotic bacteria and fructooligosaccharides may be used for promoting growth of beneficial bacteria in the gut. Methods for preparing the fruit juice beverages are also disclosed. The methods can achieve a long shelf-life while maintaining high levels of bacterial viability. The probiotic bacteria may be added to the beverage in, for example, freeze-dried or frozen form.

### FIELD OF THE INVENTION

The present invention relates to beverages. In particular, it relates to probiotic beverages.

### BACKGROUND OF THE INVENTION

Consumers are showing greater interest in their diet as a means to maintain or improve their health. Modern lifestyles leave less time to prepare and eat food and this contributes to an unhealthy diet, for example, through increased consumption of unhealthful convenience foods, which are considered to be lower in nutritional value as a result of the procedures involved in their preparation or storage. Consumption of processed foods is associated with decreased numbers of beneficial gut bacteria. Other factors known to decrease survival of beneficial bacteria in the gut include stress and consumption of red meat and alcohol. Diminished beneficial bacteria allows the growth of undesirable bacteria in the gastrointestinal tract as well as reducing the amount of nutrients produced by the beneficial bacteria.

Improved longevity in humans is resulting in increased numbers of older citizens. Relative to the population as a whole, this demographic exhibits an increased incidence of illnesses such as gastrointestinal tract infections, constipation, irritable bowel syndrome (IBS), inflammatory bowel disease (IBD), Crohn's Disease, ulcerative colitis, food allergies, diarrhea, cardiovascular disease and certain cancers such as colorectal cancer. Evidence suggests that these illnesses can be associated with decreased levels of beneficial bacteria.

In recent years, there has been an increase in the manufacture and marketing of functional foods that affect functions of the body in a targeted manner so as to bring about positive effects on physiology and nutrition. The National Center for Complementary and Alternative Medicine (NCCAM), National Institutes of Health (NIH) interprets “functional foods” as “components of the usual diet that may have biologically active components (e.g., polyphenols, phytoestrogens, fish oils, carotenoids) that may provide health benefits beyond basic nutrition.” See NCCAM, “BACKGROUNDER: Biologically Based Practices: An Overview” (October, 2004). This document may be found at the website of the National Center for Complementary and Alternative Medicine (NCCAM).

One market that has undergone expansion is food containing probiotic bacteria. Probiotic bacteria are live bacterial cultures used to supplement diets that beneficially influence the health and nutrition of the host animal by improving its intestinal microbial balance. (see Fuller, R., “Probiotics in Man and Animals,” Journal of Applied Bacteriology, 66: 365-378 (1989)). The benefits of probiotic bacteria include decreased incidence or duration of diarrhea-related illnesses, relief from irritable bowel syndrome, and reduced symptoms of lactose intolerance. Additional benefits include improvement in blood lipid levels in hyperlipidemia patients and relief from constipation. Administration of probiotics has also been shown to reduce antibiotic associated diarrhea in children and adults. (Lewis S J, Freedman A R. Review article: the use of biotherapeutic agents in the prevention and treatment of gastrointestinal disease. Aliment Pharmacol Ther. 1998 September; 12(9):807-22.)

Prebiotics are substances that are not digestible in the human gastrointestinal tract that also stimulate preferentially the growth of certain bacteria. (Schrezenmeir J. de Vrese M. Probiotics, prebiotics, and synbiotics—approaching a definition. Am. J. Clin. Nutr. 2001 February; 73(2 Suppl):361S-364S). Known prebiotics include: fructans such as inulin and fructooligosaccharides (FOS); galacto-oligosaccharides (GOS); lactulose, and maltodextrin. Fructooligosaccharides are not hydrolysed in the small intestine and instead pass through into the large intestine where they preferentially support the growth of probiotic strains of lactobacillus and bifidobacterium, increasing colonization of the colon by these probiotic bacteria. By contrast, fructooligosaccharides do not support the growth of undesirable bacteria such as species of bacteroides, clostridia, and fusobacteria (See Rao A V. J Dose-response effects of inulin and oligofructose on intestinal bifidogenesis effects. Nutr. 1999 July; 129 (7 Suppl):1442S-5S)

Synbiotic products contain both prebiotics and probiotics (See Rolfe R D. The role of probiotic cultures in the control of gastrointestinal health. J. Nutr. 2000 February; 130(2S Suppl):396S-402S and references therein). The prebiotic may promote the growth of the probiotic. Synbiotic dairy products are known in the art. Certain human groups, however, may not consume dairy products. Moreover, there is a continuing need for different products that provide probiotic bacteria to consumers to enhance beneficial bacterial growth in the gut.

Accordingly, there is a need in the art for synbiotic fruit juice beverages that maintain bacterial viability when packaged and which can promote probiotic bacterial growth in the gastro-intestinal tract.

### SUMMARY OF THE INVENTION

One aspect of the invention is a beverage containing apple juice, banana juice, pineapple juice, blueberry juice, fructooligosaccharides and probiotic bacteria contained in vessels having a tamperproof seal. The probiotic bacteria are selected from the group consisting of B. animalis (lactis) and L. rhamnosus and mixtures thereof. When refrigerated for 36 days, the juice beverage will retain ≧10⁸ CFU/fl. oz bacteria and provide ≧0.1 g/fl. oz of fructooligosaccharide.

Another aspect of the invention is a beverage containing orange juice, mango juice, pineapple juice, apple juice, fructooligosaccharides and probiotic bacteria contained in vessels having a tamperproof seal. The probiotic bacteria are selected from the group consisting of B. animalis (lactis) and L. rhamnosus and mixtures thereof. When refrigerated for 36 days, the juice beverage will retain ≧10⁸ CFU/fl. oz bacteria and provide ≧0.1 g/fl. oz of fructooligosaccharide.

A further aspect of the invention relates to methods of making a beverage such that a high number of viable bacteria are maintained. Fructooligosaccharides are combined with apple juice or banana puree and one or more other juices selected from apple, banana, blueberry, orange, mango, and pineapple to form a fruit juice/fructooligosaccharides mixture. Probiotic bacteria are combined with the fruit juice/fructooligosaccharides mixture to form the juice beverage. The bacteria may be frozen, freeze-dried, or refrigerated.

An additional aspect of the invention is a beverage containing apple juice, banana juice, pineapple juice, blueberry juice, between 0.10 and 0.15 g/fl oz fructooligosaccharides, and between 1.0×10⁹ and 1.0×10¹² CFU/fl. oz bacteria contained in vessels having a tamperproof seal. The probiotic bacteria are selected from the group consisting of B. animalis (lactis) and L. rhamnosus and mixtures thereof. When refrigerated for 36 days, between 1.0×10⁹ and 1.0×10¹² CFU/fl. oz B. animalis (lactis) bacteria remain.

An additional aspect of the invention is a beverage containing orange juice, mango juice, apple juice, pineapple juice, between 0.10 and 0.15 g/fl oz fructooligosaccharides, and between 1.0×10⁸ and 1.0×10⁹ CFU/fl. oz bacteria contained in vessels having a tamperproof seal. The probiotic bacteria are selected from the group consisting of B. animalis (lactis) and L. rhamnosus and mixtures thereof. When refrigerated for 36 days, between 1.0×10⁸ and 1.0×10⁹ CFU/fl. oz bacteria remain.

An additional aspect of the invention is a beverage containing orange juice and between 1.0×10⁸ and 1.0×10⁹ CFU/fl. oz bacteria contained in vessels having a tamperproof seal. The probiotic bacteria are selected from the group consisting of B. animalis (lactis) and L. rhamnosus and mixtures thereof. When refrigerated for 36 days, between 1.0×10⁸ and 1.0×10⁹ CFU/fl. oz bacteria remain.

### BRIEF DESCRIPTION OF THE DRAWINGS

FIGS. 1A-1D illustrate the survival of bacteria in various beverages over time. FIG. 1A shows bacteria survival using frozen bacteria with the Orange Mango Pineapple (Tropical) formulation. FIG. 1B shows bacteria survival using freeze-dried bacteria with the Orange Mango Pineapple (Tropical) formulation. FIG. 1C shows bacteria survival using frozen bacteria with the Berry formulation. FIG. 1D shows bacteria survival using freeze-dried bacteria with the Berry formulation.

FIG. 2 compares the bacterial viability in the beverages shown in FIGS. 1A-D at 36 days.

FIG. 3 shows the maintenance of bacterial viability over time in beverages having different combinations of fruit juices and bacteria. MB Bif (Mixed Berry with B. animalis (lactis)); MB Rham (Mixed Berry with L. rhamnosus); OMP Bif (Orange-Mango-Pineapple with B. animalis (lactis)); OMP Rham (Orange-Mango-Pineapple with L. rhamnosus); SB Rham (Strawberry-Banana with L. rhamnosus); SB Bif (Strawberry-Banana with B. animalis (lactis)). 4E7 and 2E8 represent the seeding bacteria levels of 4×10⁷ CFU/ml and 2×10⁸ CFU/ml, respectively, at time zero.

FIG. 4 shows the maintenance of bacterial viability over time in beverages having different single fruit juices. Rham (L. rhamnosus); Bif (B. animalis (lactis)). 4E7 represents the seeding bacteria level of 4×10⁷ CFU/ml.

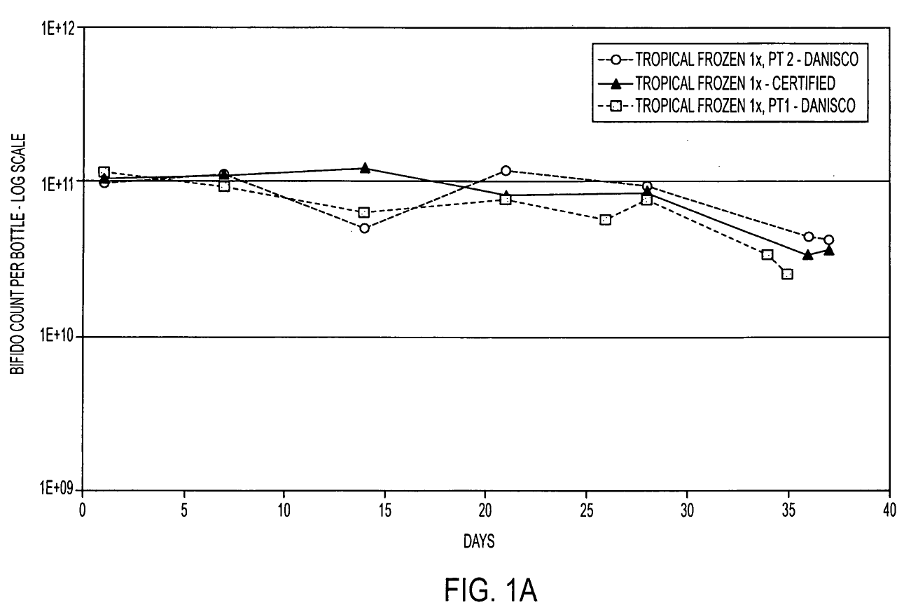

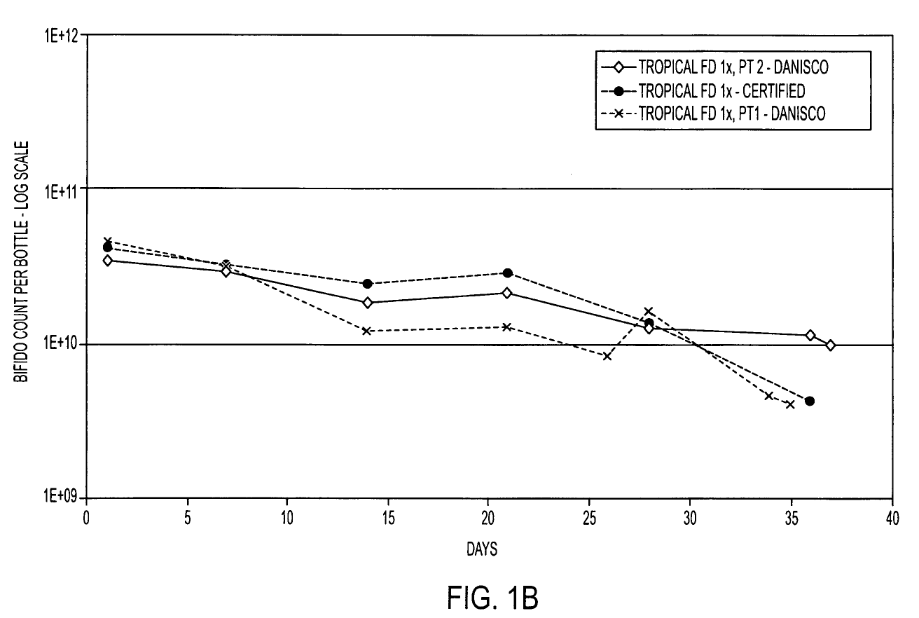

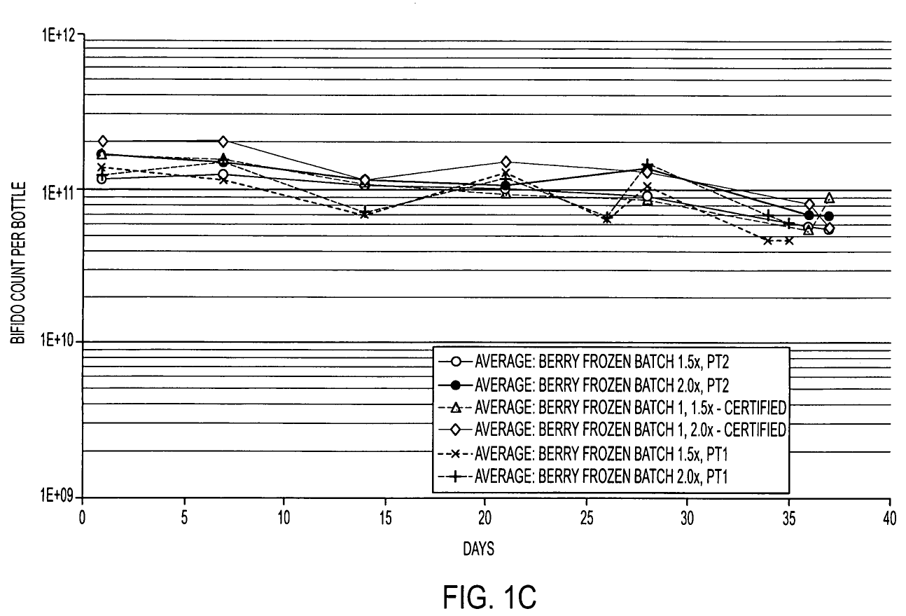

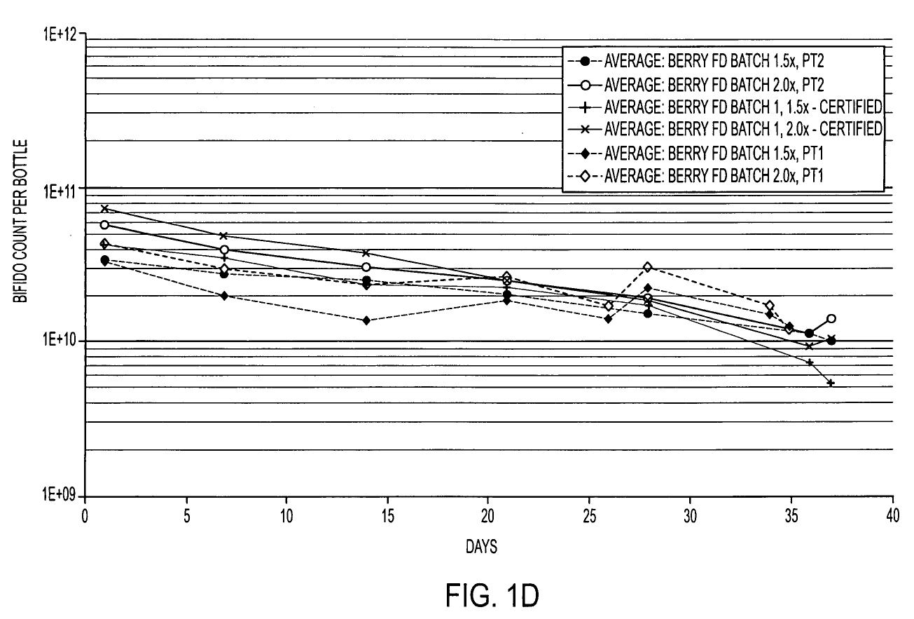

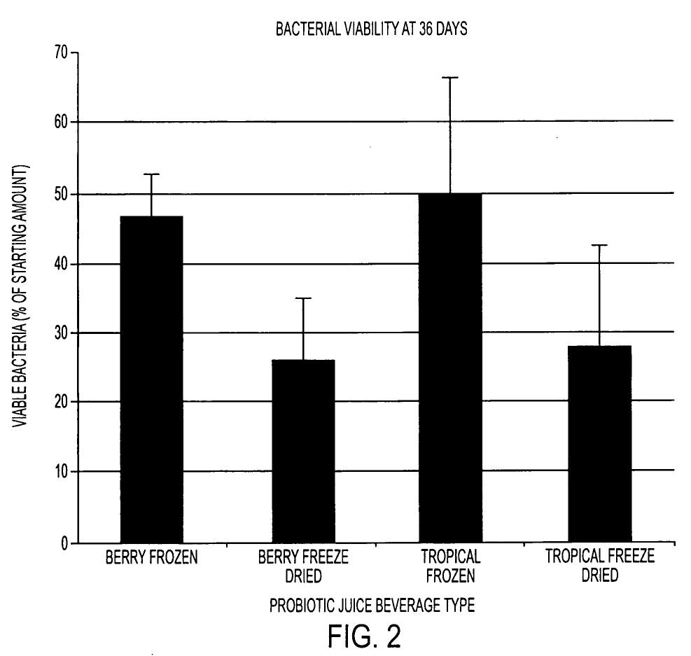

### DETAILED DESCRIPTION OF THE INVENTION

It is a discovery of the present inventors that certain probiotic beverages can achieve a long shelf-life and maintain high bacterial viability rates. These beverage products are capable of delivering ≧10⁸ CFU bacteria per fl. oz of beverage when consumed even 36 days of refrigeration post-filling.

The term ‘shelf-life’ as used herein refers to the length of time after a beverage is packaged until it is consumed or tested for viable bacteria. The beverages maintain a high number of viable bacteria during its shelf-life. The beverages maintain a high number of viable bacteria during their shelf-life providing to the consumer upon consumption a minimum level of ≧10⁸ CFU bacteria per fl. oz of beverage, ≧5×10⁸ CFU bacteria per fl. oz of beverage, ≧10⁹ CFU bacteria per fl. oz of beverage, ≧5×10⁹ CFU bacteria per fl. oz of beverage, ≧10¹⁰ CFU bacteria per fl. oz of beverage, ≧5×10¹⁰ CFU bacteria per fl. oz of beverage, ≧10¹¹ CFU bacteria per fl. oz of beverage, or ≧5×10¹¹ CFU bacteria per fl. oz of beverage. Time of consumption may be at any time from day 0 and on through 20 days, 25 days, 26 days, 27 days, 28 days, 29 days, 30 days, 31 days, 32 days, 33 days, 34 days, 35 days, 36 days, 37 days, 38 days, 39 days, 40 days, 41 days, or 42 days.

Bacteria of the genus Bifidobacterium are known to exert a beneficial influence on human health. Elevated Bifidobacteria numbers lead to increased levels of lactic and acetic acids, which decreases the pH in the digestive tract, inhibiting the growth of harmful bacteria such as Clostridium perfringens, Clostridium difficile and certain pathogenic Escherichia coli. Lactobacillus species are also known to exert a beneficial influence on many disorders and diseases including antibiotic-induced imbalances in gastrointestinal microflora, hypercholesterolemia, vaginal infections, E. coli infection and depressed immunity. Shauss A G, Method of Action, Clinical Application and Toxicity Data, 3 J. Advancement Med. 163 (1990). In vitro studies have shown that L. acidipholus can inhibit growth of pathogenic bacteria such as Helicobacter pylori, Staphylococcus aureus, Pseudomonas aeruginosa, and Sarcina lutea. Shahani K M et al., Natural Antibiotic Activity of Lactobacillus acidophilus and bulgaricus, 11 Cultured Dairy Products J. 14 (1976); Rolfe R D. The role of probiotic cultures in the control of gastrointestinal health. J. Nutr. 2000 February; 130(2S Suppl):396S-402S.

Probiotic bacterial strains of Bifidobacterium can be used in the beverages, particularly the species B. breve, B. animalis (lactis), B. Iongum, B. bifidum, B. adolescentis, B. thermophilum, and B. infantis. Probiotic bacteria of the genus Lactobacillus can also be used, particularly the species L. acidophilus, L. casei, L. rhamnosus, L, paracasei, L. johnsonii, L. reuteri and L. plantarum, L. lactis, L. bulgaricus. Some beverages may contain bacteria from multiple species. Suitable strains are available commercially such as B. animalis (lactis) HN019, L. rhamnosus HN001 and L. acidophilus NCFM, marketed by Danisco USA, Inc as HOWARU Bifido, HOWARU Rhamnosus, and HOWARU Acidophilus, respectively.

One or more bacterial species may be present in a beverage. The ratio of one bacterial species to the other may vary widely. The ratio may be from about 0.00000001 to 1, about 0.0000001 to 1, about 0.000001 to 1, about 0.00001 to 1, about 0.0001 to 1, about 0.001 to 1, about 0.01 to 1, about 0.1 to 1, about 1 to 1. When two bacteria are present in a beverage, the bacteria may be, for example, B. animalis (lactis) and L. rhamnosus. Other combinations may be used.

Viable bacterial numbers are often reported as CFU, or colony forming units. One colony is formed by a single viable bacterium when the bacteria are plated at a suitable dilution for single colony formation. This is a standard technique known to microbiologists. Typically, the amount is expressed as the number of CFU in a liquid measure such as milliliters (ml) or fluid ounces (fl. oz). U.S. regulation 21 CFR 101.9(b)(5)(viii) defines a fluid ounce as exactly 30 ml. Sufficient numbers of viable bacteria may be necessary to obtain the beneficial effects of the probiotic bacteria. Often bacteria are packaged at a certain level of viable bacteria; however, before consumption, the levels may decrease preventing the consumer from acquiring a beneficial dose of bacteria. Indeed, the National Center for Complementary and Alternative Medicine (NCCAM) has identified several issues relating to the quality of probiotic products including: viability of the bacteria in the product, types and titer of bacteria in the product, and stability under storage. “BACKGROUNDER: Biologically Based Practices: An Overview,” cited above.

Types of prebiotics that may optionally be used in products for human consumption include inulin, fructooligosaccharides (FOS); galacto-oligosaccharides (GOS), lactulose, and maltodextrin. These may be naturally produced in a plant, semi-synthetic, synthetic, recombinant, etc. Typically these will be used in a semi-purified state, in which other components of the plant, fruit, flower, or vegetable source, or other components of the synthetic or semi-synthetic reaction are diminished inn concentration and/or removed.

Inulin is a naturally occurring soluble fiber composed of a mixture of oligomers of varying degrees of polymerizations. Inulins are mainly comprised of fructose units and typically have a terminal glucose. Plant inulins generally contain between 2 to 140 fructose units. Inulin can be obtained from a variety of sources including Jerusalem artichoke, dahlia, onion, garlic and chicory tubers. Maltodextrin is a moderately sweet polysaccharide produced from corn starch. Lactulose is a synthetic sugar, which does not occur naturally. The disaccharide lactulose (galacto-fructose) is synthesized from lactose (galacto-glucose) by isomerisation of glucose to fructose. Galacto-oligosaccharides (GOS) can also be synthesized from lactose; for example, by using β-galactosidase enzymes purified from Lactobacillus reuteri L103 as a catalyst.

Fructooligosaccharides may be prepared by any of several methods known in the art. For example, fructooligosaccharides can be extracted from natural substances. Fructooligosaccharides occur in many kinds of plants including dahlias, chicory, onions, garlic, shallots, wheat rye, artichokes and tomatoes. Fructooligosaccharides may also be produced enzymatically through chemical techniques. For example, fructooligosaccharides may be synthesized by treating sucrose with enzymes such as fructosyltransferases (EC 2.4.1.9) and fructofuranosidases (EC 3.2.1.26) Hidaka H. et al. A fructooligosaccharides-producing enzyme from Aspergillus niger ATCC 20611. Agric. Biol. Chem. 1988; 52:1181-1187. Fructooligosaccharides are particularly well-known for use in promoting the growth of Bifidobacterium species. (Rossi M, Corradini C, Amaretti A, Nicolini M, Pompei A, Zanoni S, Matteuzzi D. Fermentation of fructooligosaccharides and inulin by bifidobacteria: a comparative study of pure and fecal cultures. Appl Environ Microbiol. 2005 October; 71(10):6150-8.)

Fructooligosaccharides are typically linear chains of fructose bound to a terminal glucose. The fructooligosaccharides can be a mixture of short chain polymers. The length of the fructose chain, also called the degree of polymerization or DP, can be from about 2 to about 5. Typically, the fructose chain length varies from 2 to 4. Such short-chain fructooligosaccharides may also be referred to as GF2 (1-kestose), GF 3 (nystose), and GF4 (1-β-fructofuranosyl nystose). Suitable commercially available fructooligosaccharides may be used, for example, Nutraflora® by GTC Nutrition (Golden, Colo. 80401).

The bacteria may be prepared in a variety of ways known in the art, including, for example, growth on media containing casein. Optionally, the bacteria may be grown without casein, providing a completely dairy-free bacterial preparation. The bacteria may be stored by refrigeration, freezing, or freeze-drying without diminishing viability below a desired level. The bacteria may be added to the beverage while in the same state as they were stored, such as while frozen, freeze-dried, or refrigerated. Optionally, the bacteria may be thawed prior to adding to the beverage. The bacteria may be frozen after growth and maintained in a frozen state until they are added to the beverage.

In one method for preparing the fruit juice beverage, the fructooligosaccharides are combined with fruit juices, the fructooligosaccharides/juice mixture is pasteurized, then the frozen bacteria are added to the fructooligosaccharides/juice mixture. Provided that the bacteria are not pasteurized, the other ingredients may be pasteurized and combined in any suitable order. The fruit juices may be in various forms including liquids, concentrates, extracts, purees, pastes, pulps, and the like. The juice beverage is dispensed into bottles, cartons, or vessels, and sealed by suitable methods known in the art. The sealed containers can be shipped or stored optionally under refrigeration. Refrigeration temperatures typically have a lower limit of about 0° C., about 2° C., about 4° C., about 6° C., about 8° C., or about 10° C. Refrigeration temperatures typically have an upper limit of about 4° C., about 6° C., about 8° C., or about 10° C. Often, the refrigeration temperature is about 2° C. to about 6° C.

In another method for preparing the fruit juice beverage, the bacteria are added to an apple juice extract in one container to form a slurry under conditions that minimize contamination of the slurry with other undesirable bacteria. In a separate container fructooligosaccharides are combined with fruit juices. The fruit juices may be in various forms including concentrates, extracts, purees, pastes, pulps, and the like. The slurry and the fruit juice/fructooligosaccharides mixture are blended together to form a final beverage, which is dispensed into bottles, cartons, or vessels, and sealed by suitable methods known in the art. The sealed containers can be shipped or stored, optionally under refrigeration. Refrigeration temperatures typically have a lower limit of about 0° C., about 2° C., about 4° C. about 6° C. about 8° C., or about 10° C. Refrigeration temperatures typically have an upper limit of about 4° C., about 6° C., about 8° C., or about 10° C. Often, the refrigeration temperature is about 2° C. to about 6° C.

A suitable fruit juice combination for the beverage includes juices from apple, banana, orange, mango, and pineapple. This beverage is referred to herein as Orange-Mango-Pineapple or OMP. Bacterial species that exhibit excellent survival in this beverage include B. animalis (lactis). A second suitable fruit juice combination termed “Berry” or “Blueberry” includes juices from apple, banana, and blueberry. Orange juice was also found to maintain excellent survival of L. rhamnosus.

Vitamins and minerals can be added to the juice beverages. Any suitable vitamin may be added. For example, the added vitamins may be one or more of: Vitamin A, Vitamin B1, Vitamin B2, Vitamin B3 (niacin), Vitamin B5 (pantothenic acid), Vitamin B6, Vitamin B7, Vitamin B9, Vitamin B12, Vitamin C, Vitamin D, Vitamin E, or Vitamin K. Any suitable mineral may be added. For example, the added minerals may be one or more of calcium, chloride, chromium, magnesium, phosphorus, potassium, sodium, sulfur, cobalt, copper, fluorine, iodine, iron, manganese, molybdenum, nickel, selenium, vanadium, zinc. The vitamins and minerals may be added in any form compatible with human nutritional requirements. The vitamins and minerals may be added to any desired level. The amounts in the beverage may be at any suitable percentage of the Reference Daily Intake (RDI). For example, the vitamin or mineral may be present at an upper limit of about: 2%, 5%, 10%, 20%, 25%, 30%, 40%, 50%, 60%, 75%, 100%, 150%, 200%, 300%, 400%, or about 500% of the RDI. The vitamin or mineral may be present at a lower limit of about: 1%, 2%, 5%, 10%, 20%, 25%, 30%, 40%, 50%, 60%, 75%, 100%, 150%, 200%, or about 300% of the RDI. Alternatively, the amount of added vitamin or mineral may be measured in international units (IU) or weight/weight (w/w). For example, a beverage serving may contain 100% of the RDI of each of Vitamin E, Vitamin B3 (niacin), Vitamin B5 (pantothenic acid), Vitamin B6, and Vitamin B12.

Optionally, additional ingredients known or expected to have beneficial effects may be added. For example, the beverage may contain one or more of the following: oils such as omega-3 or omega-6, herbs and spices. The herbs and spice ingredients may be in extracted form. Any suitable herb and spice known in the art may be used as an ingredient. Exemplary herbs and spices that may be added include Kava Kava, St. John's Wort, Saw Palmetto, and ginseng.

The state of the bacterial inoculum can influence the survival of the bacteria in the juice beverage. Previously, the bacteria have been added in freeze-dried form. The inventors have discovered that addition of frozen bacteria provides an unexpected improvement in bacterial survival in the beverage. The percentage of bacteria added to the beverage that remain viable at the end of the storage period has an upper limit of about: 10%, 15%, 20%, 25%, 30%, 35%, 40%, 45%, 50%, 55%, 60%, 65%, 70%, 75%, 80%, 85%, 90%, 95% or 100%. The percentage of bacteria added to the beverage that remain viable at the end of storage has a lower limit of about 10%, 15%, 20%, 25%, 30%, 35%, 40%, 45%, 50%, 55%, 60%, 65%, 70%, 75%, 80%, 85 or about 90%.

The juices may be present in the beverage in various amounts with respect to each other. Equal amounts of each juice may be present. Each juice may also be present in greater amounts than one or more juices. There may be about 10-50% more of one juice than another juice, about 50-100% more than another juice, about 100-200% more than another juice, about 200-300% more than another juice, about 300-500% more than another juice, or about 500-1000% more than another juice. In a Berry juice mixture, the apple juice may be present at between 40 and 80% of the juices; the pineapple juice may be present at between 5 and 15% of the juices; banana puree may be present at between 10 and 25% of the juices; and blueberry puree may be present at between 2 and 10% of the juices. In a Tropical juice mixture, the apple juice may be present at between about 20 and 50%; the mango puree juice) can be present at between 10 and 40%, the orange juice can be present at between 15 and 35%, the pineapple juice can be present at between 5 and 20%; and the banana puree juice) can be present at between 2 and 12%. Such percentages are weight/weight percentages.

The amount of apple juice has a lower limit of about 2%, about 5%, about 10%, about 20%, about 30%, or about 35%, of the total beverage. The amount of apple juice has an upper limit of about 40%, about 50%, about 60%, or about 70%, of the total beverage. Typically, the amount of apple juice is between 30 and 70% of the total beverage.

The Brix of a juice is equivalent to the total measure of the soluble solids in the fruit juice. The soluble solids mainly comprise sugars (sucrose, fructose and glucose) and therefore Brix is considered a measure of sugar present in the juice. To refer to Brix we use Brix degrees, which are equivalent to percentages. The Brix value of the beverages has a lower limit of about 13.5, about 14.0, about 14.5, about 15.0, about 15.5, or about 16.0. The Brix value of the beverages has an upper limit of about 14.0, about 14.5, about 15.0, about 15.5, about 16.0, about 16.5, about 17.0, about 17.5, or about 18.0. Often the Brix values of the juice beverages is in the range from about 14.0 to about 15.0.

The pH values of the beverages have a lower limit of about 3.2, about 3.6, about 3.8, or about 4.0. The pH values of the beverages have an upper limit of about 3.6, about 3.8, about 4.0, or about 4.2. Often, the pH range is about 3.4 to about 3.9.

At 36 days of refrigeration after preparation of the beverage, the number of bacteria contained in the beverage has a lower limit of about 10⁶ CFU/fl. oz, about 5×10⁶ CFU/fl. oz, about 10⁷ CFU/fl. oz, about 5×10⁷ CFU/fl. oz, about 10⁸ CFU/fl. oz, about 5×10⁸ CFU/fl. oz, about 10⁹ CFU/fl. oz, or about 5×10⁹ CFU/fl. oz. At 36 days of refrigeration after preparation of the beverage, the number of bacteria contained in the beverage has an upper limit of about 10⁸ CFU/fl. oz, about 5×10⁸ CFU/fl. oz, about 10⁹ CFU/fl. oz, about 5×10⁹ CFU/fl. oz, about 10¹⁰ CFU/fl. oz, about 5×10¹⁰ CFU/fl. oz, about 10¹¹ CFU/fl. oz, about 5×10¹¹ CFU/fl. oz, about 10¹² CFU/fl. oz, or about 5×10¹² CFU/fl. oz. Viability can be assessed at any convenient time post-production between about 30 and 36 days.

The amount of fructooligosaccharides present in the beverages has a lower limit of about 0.01 g/fl. oz, about 0.05 g/fl. oz, about 0.1 g/fl. oz, about 0.13 g/fl. oz about 0.5 g/fl. oz, about 1 g/fl. oz, about 1.5 g/fl. oz, or about 2 g/fl. oz. The amount of fructooligosaccharides present in the beverages has an upper limit of about 0.1 g/fl. oz, about 0.5 g/fl. oz, about 1 g/fl. oz about 1.5 g/fl. oz, about 2 g/fl. oz, about 2.5 g/fl. oz, or about 3 g/fl. oz.

Often, bottles capable of containing 10 fl. oz are used as containers for the beverage. Typically, a beverage manufactured according to this process will retain sufficient bacterial viability for extended periods such that a 10 fl. oz serving will provide to the consumer ≧5×10⁹ CFU of bacteria and ≧1 g of fructooligosaccharides. Often, the 10 fl. oz serving will have 5×10⁹ CFU of bacteria and 1.33 g of fructooligosaccharides.

### EXAMPLE 1

### Preparation of Orange Mango Pineapple (Tropical) Beverage Using Frozen Bacteria

Apple juice, banana puree, mango juice, orange juice, and pineapple juice were combined with sufficient fructooligosaccharides to give around 0.1 g/fl. oz fructooligosaccharides. The mixture was briefly pasteurized then pumped into a finished product tank. The probiotic bacteria were added slowly in frozen form and mixed with the fruit juice mixture to form the final beverage. For the tropical beverage approximately 1151×10¹¹ cfu were added per 300 gal of juice/fructooligosaccharide mixture.

### EXAMPLE 2

### Preparation of Berry Beverage Using Frozen Bacteria

The berry beverage was prepared with apple juice, pineapple juice, banana puree and blueberry puree combined with sufficient fructooligosaccharides to give around 0.1 g/fl. oz fructooligosaccharides according to the method of example 1. For the berry beverage, approximately 1535 DCU were added per 300 gal of juice/fructooligosaccharide mixture. In addition vitamins and minerals were added to give 100% of the RDI of the following vitamins per serving of beverage: Vitamin E (30 IU), Niacin (20 mg), Pantothenic acid (10 mg), Vitamin B12 (6 μg) and Vitamin B6 (2 mg). Ascorbic Acid was added at 0.36% w/w. This combination of ingredients provided unexpectedly good bacterial survival. In particular, the inclusion of the vitamins and minerals gave improved bacterial viability compared to berry beverage prepared without the vitamins and minerals.

### EXAMPLE 3

### Preparation of Orange Mango Pineapple Probiotic Juice Using Freeze-Dried Bacteria

Apple juice was pasteurized and then stored in a 2,000 gallon tank in a clean Product tank. The apple juice was then transferred into a Probiotic Innoculation Slurry tank. Once in the tank, stirring was applied to create a vortex and one or more sachets of bacteria were added and mixed into the apple juice to form the slurry.

The probiotic bacteria is packaged to prevent contamination. The bacteria may be stored chilled for periods of about three months or frozen for about a year.

The tanks have been sterilized prior to use for storing, or mixing any of the ingredients of the beverage. Sterilization may be performed by any suitable method. For example, sterilization may be achieved by autoclaving, or by use of sanitizing solutions. The outer surface of the packaging containing the probiotic has also been sterilized before addition to the slurry tank. These and other approaches are used to minimize the presence of undesired organisms in the final beverage.

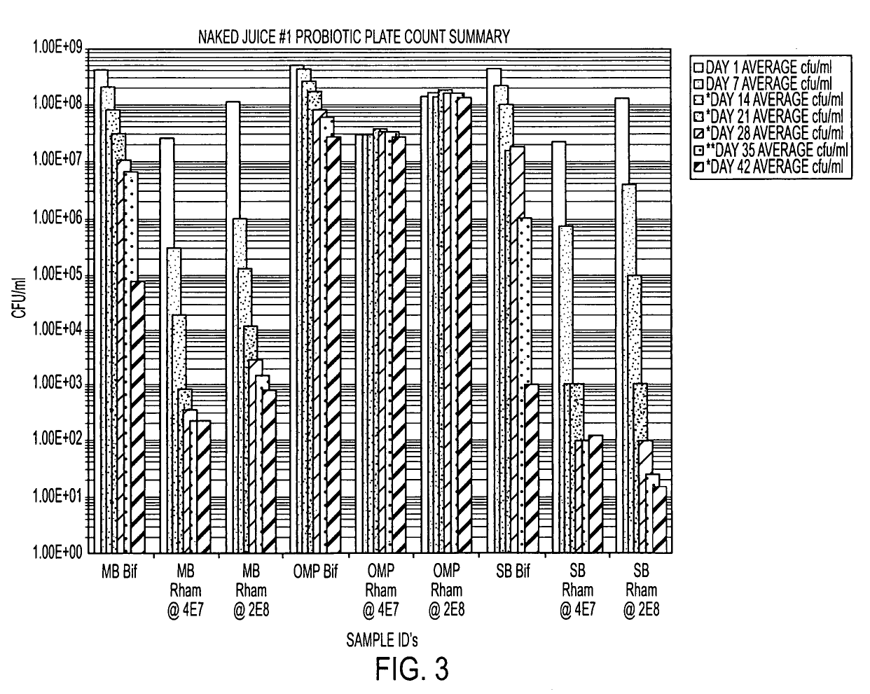

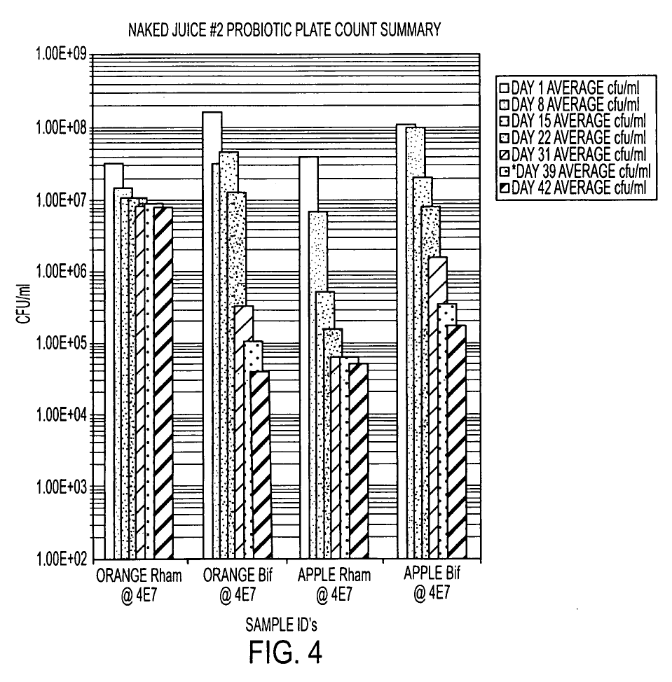

The probiotic bacteria are added to the apple juice slowly and thoroughly. When all the bacteria were added, mixing was continued until the freeze-dried particles dissolved in the apple juice. The correct amount of bacteria to add to the beverage to retain the desired amount of live bacteria at the end of the shelf-life period may readily be determined without undue experimentation. For example, FIG. 3 shows bacterial survival data useful in making this determination. Typically, between four and eight sachets each containing 1-2.5 Kg of bacteria are added to achieve the desired amount.

In a second 2000 gallon tank, the remaining juices were mixed with the fructooligosaccharides to form a juice/fructooligosaccharides mixture.

Finally, the slurry was transferred from the Slurry Tank to the 2000 Gallon tank containing the juice/fructooligosaccharides mixture. The slurry and juice/fructooligosaccharides mixture were blended thoroughly. For a two minute period, the blended mixture was re-circulated through the Slurry tank. The completed beverage was then poured into containers. Additional batches may be created with only a brief wash of the Slurry tank provided that the additional batches are started within 15 minutes. A longer delay than this requires that the slurry tank is thoroughly cleaned.

In this example, bacteria were mixed with 120 gallons of apple juice in the Slurry Tank. The amount of bacteria can be adapted so as to achieve the desired amount of bacteria in the final beverage. Typically, a sachet contains about 2 kg of bacteria. In this example 8 sachets were used. The Slurry was added to 1680 gallons of juice/fructosaccharides mixture to give a final volume of 1800 gallons. These amounts may be scaled to suit the desired final amounts of beverage.

1. A vessel filled to contain a beverage and having a tamperproof seal, said beverage comprising:
(i) apple juice;
(ii) banana juice;
(iii) blueberry juice;
(iv) pineapple juice;
(v) ≧0.1 g/fl. oz fructooligosaccharides; and
(vi) ≧10⁸ CFU/fl. oz of bacteria selected from the group consisting of Bifidobacterium animalis (lactis), Lactobacillus rhamnosus, and mixtures thereof,
wherein when said beverage is refrigerated for 36 days ≧10⁸ CFU/fl. oz of said bacteria remain.

2. A vessel filled to contain a beverage and having a tamperproof seal, said beverage comprising:
(i) orange juice;
(ii) mango juice;
(iii) pineapple juice;
(iv) apple juice;
(v) ≧0.1 g/fl. oz fructooligosaccharides; and
(vi) ≧10⁸ CFU/fl. oz of bacteria selected from the group consisting of Bifidobacterium animalis (lactis) Lactobacillus rhamnosus, and mixtures thereof,
wherein when said beverage is refrigerated for 36 days ≧10⁸ CFU/fl. oz of the bacteria remain.

3. The beverage of claim 1 or 2 which comprises ≧0.5 g/fl. oz fructo-oligosaccharides.

4. The beverage of claim 1 or 2 which comprises ≧1 g/fl. oz fructooligosaccharides.

5. The beverage of claim 1 or 2 which comprises ≧5×10⁸ CFU/fl. oz of said bacteria.

6. The beverage of claim 1 or 2 which comprises ≧10⁹ CFU/fl. oz of said bacteria.

7. The beverage of claim 1 or 2 wherein the bacteria are Bifidobacterium animalis (lactis).

8. The beverage of claim 1 or 2 wherein the bacteria are Lactobacillus rhamnosus.

9. The beverage of claim 1 or 2 wherein the bacteria are a mixture of Bifidobacterium animalis (lactis) and Lactobacillus rhamnosus.

10. The vessel of claim 2 wherein the beverage further comprises banana juice.

11. A method of preparing a juice beverage capable of maintaining a high number of viable bacteria, comprising:
combining fructooligosaccharides with apple juice and one or more fruit juices selected from the group consisting of: banana, blueberry, orange, mango, and pineapple fruit juices to form a fruit juice/fructooligosaccharide mixture;
combining bacteria selected from the group consisting of Bifidobacterium animalis (lactis), Lactobacillus rhamnosus, and mixtures thereof, with the fruit juice/fructooligosaccharide mixture to form a juice beverage.

12. The method of claim 11 wherein said beverage contains ≧0.1 g/fl. oz fructooligosaccharides.

13. The method of claim 11 wherein said beverage contains ≧0.5 g/fl. oz fructooligosaccharides.

14. The method of claim 11 wherein said beverage contains ≧1 g/fl. oz fructooligosaccharides.

15. The method of claim 11 further comprising: filling vessels with the juice beverage and sealing the filled vessels.

16. The method of claim 11 wherein the bacteria are Bifidobacterium animalis (lactis).

17. The method of claim 11 wherein the bacteria are Lactobacillus rhamnosus.

18. The method of claim 11 wherein the bacteria are a mixture of Bifidobacterium animalis (lactis) and Lactobacillus rhamnosus.

19. The method of claim 11 further comprising storing the juice beverage under refrigeration for at least 30 days.

20. The method of claim 11 further comprising testing the juice beverage for viable bacteria at between 30 and 36 days.

21. The vessel of claim 1 or 2 wherein said beverage comprises:
(i) between 0.10 and 0.15 g/fl. oz fructooligosaccharides; and
(ii) between 1.0×10⁸ and 1.0×10¹² CFU/fl. oz of Bifidobacterium animalis (lactis) bacteria; wherein when the beverage is refrigerated for 36 days, between 1.0×10⁸ and 1.0×10¹² CFU/fl. oz of said bacteria remain.

22. The vessel of claim 1 or 2 wherein said beverage comprises:
(i) between 0.10 and 0.15 g/fl. oz fructooligosaccharides; and
(ii) between 1.0×10⁸ and 1.0×10⁹ CFU/fl. oz of Bifidobacterium animalis (lactis) bacteria; wherein when the beverage is refrigerated for 36 days, between 1.0×10⁸ and 1.0×10⁹ CFU/fl. oz of said bacteria remain.

23. The vessel of claim 1 or 2 wherein said beverage comprises:
(i) between 0.10 and 0.15 g/fl. oz fructooligosaccharides; and
(ii) between 1.0×10⁹ and 1.0×10¹² CFU/fl. oz of Bifidobacterium animalis (lactis) bacteria; wherein when the beverage is refrigerated for 36 days, between 1.0×10⁹ and 1.0×10¹² CFU/fl. oz of said bacteria remain.

24. The vessel of claim 21, 22, or 23 wherein the beverage further comprises banana juice.
